(19) United States
(12) Patent Application Publication
(10) Pub. No.: US 2026/0323511 A1
(43) Pub. Date: Oct. 15, 2026

(54) METHOD FOR DYNAMIC DRX CYCLE CONFIGURATION

(71) Applicant: AUMOVIO Germany GmbH, Frankfurt am Main (DE)

(72) Inventors: Rikin Shah, Langen, Hessen (DE); David Gonzalez Gonzalez, Egelsbach, Hessen (DE); Hojin KIM, Regensburg (DE); Andreas ANDRAE, Friedberg (DE); Reuben GEORGE STEPHEN, Singapore (SG); Shravan Kumar KALYANKAR, Singapore (SG)

(73) Assignee: AUMOVIO Germany GmbH, Frankfurt am Main (DE)

(21) Appl. No.: 19/481,577

(22) PCT Filed: May 8, 2024
(86) PCT No.: PCT/EP2024/062669

§ 371 Date: Nov. 5, 2025

(30) Foreign Application Priority Data
May 11, 2023 (DE) DE102023204348.3

(51) Int. Cl. H04W 52/02; H04W 72/231

(52) U.S. Cl. CPC H04W 52/0216; H04W 72/231

(57) ABSTRACT

A method for discontinuous reception, DRX, configuration, the method being implemented by a user equipment, UE. The UE is configured with a DRX cycle value through radio resource control, RRC, signaling. The method includes: in response to receiving from a base station, BS, via downlink control information, DCI, or medium access control, MAC, control element, CE, an indication of an adjustment of the DRX cycle value: modifying the DRX cycle value based on the indicated adjustment; in response to receiving no adjustment indication from the BS: continuing with the same DRX cycle value.

### CROSS REFERENCE TO RELATED APPLICATION

This application is the U.S. National Phase Application of PCT International Application No. PCT/EP2024/062669, filed May 8, 2024, which claims priority to German Patent Application No. 10 2023 204 348.3, filed May 11, 2023, the contents of such applications being incorporated by reference herein.

### FIELD OF THE INVENTION

The present disclosure relates to wireless communication systems and relates more specifically to methods and devices for enabling a dynamic configuration of a discontinuous reception, DRX, cycle at a user equipment, UE. Such a dynamic configuration can be used, for example, in the context of extended reality, XR.

### BACKGROUND OF THE INVENTION

For the NR technology, DRX procedures for downlink (DL)/uplink (UL) communication via the Uu radio interface are specified in 3GPP TS 38.321 V16.0.0 (2020-03), incorporated herein by reference. Based on these procedures, expected UE behavior in terms of reception and processing of transmissions can be controlled. The underlying DRX functionalities are based on defining a DRX active time, in which the UE is expected to receive and process incoming transmissions. For example, the UE is expected to decode the DL control channels, process received grants, etc. Outside the DRX active time, in what is also denoted as DRX inactive time, there is no expectation on the UE to receive and process transmissions. Accordingly, an access node, in the NR technology denoted as “gNB”, cannot assume that the UE will be listening to DL transmissions. A DRX configuration may also define transitions between states. Typically, UEs that are not in the DRX active time turn off some of their components and enter a low-power mode, e.g., a sleeping mode. To ensure that the UE regularly switches to the DRX active time, i.e., wakes up from the sleeping mode, a DRX cycle is defined. The DRX cycle may basically be based on two parameters: a periodicity (value) of the DRX cycle, which controls how frequently the UE switches to the DRX active time, and a duration of the DRX active time, which controls for how long the UE is in the DRX active state.

According to section 5.7 of 3GPP TS 38.321 V16.0.0, when a DRX cycle is configured, the active time for serving cells in a DRX group includes the time while a drx-onDurationTimer or a drx-InactivityTimer configured for the DRX group is running; or a drx-RetransmissionTimerDL or a drx-RetransmissionTimerUL is running on any serving cell in the DRX group; or an ra-ContentionResolutionTimer (as described in clause 5.1.5) or a msgB-ResponseWindow (as described in clause 5.1.4a) is running; or a scheduling request (SR) is sent on PUCCH and is pending (as described in clause 5.4.4); or a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a).

Currently, the DRX cycle period (value) is configured via radio resource control, RRC, signaling and current specifications allow a single DRX cycle configuration per serving cell.

In applications such as XR, it is possible to have devices which may support multiple traffic flows such as audio, video, I/P frame. Furthermore, each traffic flow can have different traffic pattern with different traffic periodicity. However, a single DRX configuration cannot match the characteristics of all possible XR traffic flows. As a result, latency of downlink (DL) data would increase and/or UE power consumption would increase.

### SUMMARY OF THE INVENTION

The present disclosure aims at improving the situation. In particular, the present disclosure aims at addressing at least some of the limitations of the prior art discussed above. In particular, the present disclosure aims at proposing a solution enabling to reduce DL data latency and signaling overhead.

For that purpose, it is proposed that the network configures the DRX cycle value dynamically for each DRX cycle.

According to a first aspect, the present disclosure relates to a method for discontinuous reception, DRX, configuration, the method being implemented by a user equipment, UE, wherein the UE is configured with a DRX cycle value through radio resource control, RRC, signaling, wherein the method comprises:
in response to receiving from a base station, BS, via downlink control information, DCI, or medium access control, MAC, control element, CE, an indication of an adjustment of the DRX cycle value: modifying the DRX cycle value based on the indicated adjustment,
in response to receiving no adjustment indication from the BS: continuing with the same DRX cycle value.

Hence, the DRX cycle value may be configured semi-statically by the radio access network, RAN, for instance as a short DRX cycle or long DRX cycle, via RRC signaling. However, the DRX cycle value may be adjusted at each DRX cycle, for example via DCI or MAC CE. For example, the DRX cycle value may be adjusted to the considered traffic flow, thereby reducing DL data latency at the UE. Of course, it is possible to consider more than two different values for the DRX cycle.

In some embodiments, the method according to the first aspect can further comprise one or more of the following optional features, considered either alone or in any technically possible combination.

In some embodiments of the method according to the first aspect, the adjustment of the DRX cycle value is determined based on an index indicated by the BS.

In some embodiments of the method according to the first aspect, the adjustment of the DRX cycle value is determined based on a mapping table between a plurality of indexes and respective DRX cycle values.

In some embodiments of the method according to the first aspect, the mapping table between a plurality of indexes and respective DRX cycle values is received by the UE through a dedicated RRC signaling message.

In some embodiments of the method according to the first aspect, the mapping table between a plurality of indexes and respective DRX cycle values is received by the UE through an RRC reconfiguration message.

In some embodiments of the method according to the first aspect, different index further configure different DRX related timer, whereby the different DRX related timer include drx-onDurationTimer and/or drx-InactivityTimer and/or drx-RetransmissionTimer. Hence, in such embodiments, it is possible to adjust not only the value (duration) of the DRX cycle, but also the values of the different timers which define the active time and the inactive time of within the DRX cycle.

In some embodiments of the method according to the first aspect, the adjustment indication is UE specific.

In some embodiments of the method according to the first aspect, the DRX cycle comprising an active time and an inactive time, the adjustment indication is received during the active time of the DRX cycle.

In some embodiments of the method according to the first aspect, the RRC signaling used to configure the DRX cycle value is a dedicated RRC signaling message, for example an RRC reconfiguration message.

According to a second aspect, the present disclosure relates to a user equipment, UE, comprising a wireless transceiver, a processor coupled with a memory in which computer program instructions are stored, said instructions being configured to implement a method according to any one of the embodiments of the first aspect.

According to a third aspect, the present disclosure relates to a method for discontinuous reception, DRX, configuration, the method being implemented by a base station, BS, wherein a UE is configured with a DRX cycle value through radio resource control, RRC, signaling, wherein the method comprises transmitting to the UE an indication of an adjustment of the DRX cycle value via downlink control information, DCI, or medium access control, MAC, control element, CE.

In some embodiments, the method according to the third aspect can further comprise one or more of the following optional features, considered either alone or in any technically possible combination.

In some embodiments, the method according to the third aspect comprises determining an index and transmitting the index as an indication of an adjustment of the DRX cycle value.

In some embodiments of the method according to the third aspect, the index is determined based on a traffic flow of the UE.

In some embodiments, the method according to the third aspect comprises transmitting to the UE a mapping table between a plurality of indexes and respective DRX cycle values.

In some embodiments of the method according to the third aspect, the mapping table between a plurality of indexes and respective DRX cycle values is transmitted to the UE through a dedicated RRC signaling message.

In some embodiments of the method according to the third aspect, the mapping table between a plurality of indexes and respective DRX cycle values is transmitted to the UE through an RRC reconfiguration message.

In some embodiments of the method according to the third aspect, different index further configure different DRX related timer, whereby the different DRX related timer include drx-onDurationTimer and/or drx-InactivityTimer and/or drx-RetransmissionTimer.

In some embodiments of the method according to the third aspect, the adjustment indication is UE specific.

In some embodiments of the method according to the third aspect, the DRX cycle comprising an active time and an inactive time, the adjustment indication is transmitted during the active time of the DRX cycle.

In some embodiments of the method according to the third aspect, the RRC signaling used to configure the DRX cycle value is a dedicated RRC signaling message, for example an RRC reconfiguration message.

According to a fourth aspect, the present disclosure relates to a base station, for example a gNB, comprising a wireless transceiver, a processor coupled with a memory in which computer program instructions are stored, said instructions being configured to implement a method according to any one of the embodiments of the third aspect.

According to a fifth aspect, the present disclosure relates to a wireless communication system comprising a base station, for example a gNB, according to any one of the embodiments of the present disclosure and a user equipment, UE, according to any one of the embodiments of the present disclosure.

### BRIEF DESCRIPTION OF FIGURES

Aspects of the invention will be better understood upon reading the following description, given as an example that is in no way limiting, and made in reference to the figures which show:

FIG. 1 is a schematic representation of an example of a user equipment, UE,

FIG. 2 is a schematic representation of an example of a BS,

FIG. 3 shows an exemplary flow proceeded by a gNB,

FIG. 4 shows an exemplary flow proceeded by a UE,

FIG. 5 shows an example in which the UE starts a DRX cycle as DRX C2 upon receiving an indication of an index X2 from the network and starts a DRX cycle as DRX C3 upon receiving an indication of an index X3 from the network.

### DETAILED DESCRIPTION

The detailed description set forth below, with reference to annexed drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In particular, although terminology from 3GPP 5G NR may be used in this disclosure to exemplify embodiments herein, this should not be seen as limiting the scope of the invention.

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step. Any feature of any of the embodiments disclosed herein may be applied to any other embodiment, wherever appropriate. Likewise, any advantage of any of the embodiments may apply to any other embodiments, and vice versa. Other aspects, features and advantages of the enclosed embodiments will be apparent from the following description.

In some embodiments, a more general term “network node” may be used and may correspond to any type of radio network node or any network node, which communicates with a UE (directly or via another node) and/or with another network node. Examples of network nodes are NodeB, MeNB, ENB, a network node belonging to MCG or SCG, base station (BS), multi-standard radio (MSR) radio node such as MSR BS, eNodeB, gNodeB, network controller, radio network controller (RNC), base station controller (BSC), relay, donor node controlling relay, base transceiver station (BTS), access point (AP), transmission points, transmission nodes, RRU, RRH, nodes in distributed antenna system (DAS), core network node (e.g. Mobile Switching Center (MSC), Mobility Management Entity (MME), etc.), Operations & Maintenance (O&M), Operations Support System (OSS), Self-Optimized Network (SON), positioning node (e.g. Evolved-Serving Mobile Location Centre (E-SMLC)), Minimization of Drive Tests (MDT), test equipment (physical node or software), etc.

In some embodiments, the non-limiting term user equipment (UE) or wireless device may be used and may refer to any type of wireless device communicating with a network node and/or with another UE in a cellular or mobile communication system. Examples of UE are target device, device to device (D2D) UE, machine type UE or UE capable of machine to machine (M2M) communication, PDA, PAD, Tablet, mobile terminals, smart phone, laptop embedded equipped (LEE), laptop mounted equipment (LME), USB dongles, UE category M1, UE category M2, ProSe UE, V2V UE, V2X UE, etc.

Additionally, terminologies such as base station/gNodeB and UE should be considered non-limiting and do in particular not imply a certain hierarchical relation between the two; in general, “gNodeB” could be considered as device 1 and “UE” could be considered as device 2 and these two devices communicate with each other over some radio channel. And in the following the transmitter or receiver could be either gNodeB (gNB), or UE.

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment. Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

FIG. 1 represents schematically an example of a UE 10 suitable for implementing any method, discussed in the present disclosure, performed at a UE 10. As illustrated by FIG. 1, the UE 10 comprises a processor 11 coupled to a memory 12. The memory 12 may store a computer program product 13, in the form of computer program instructions to be executed by the processor 11 to implement a method for DRX configuration, performed at a UE's side, according to any one of the embodiments disclosed herein. As illustrated by FIG. 1, the UE 10 comprises also a wireless transceiver 14 configured to exchange data with a base station, BS, 20. For example, the wireless transceiver 14 is a 5G NR wireless transceiver.

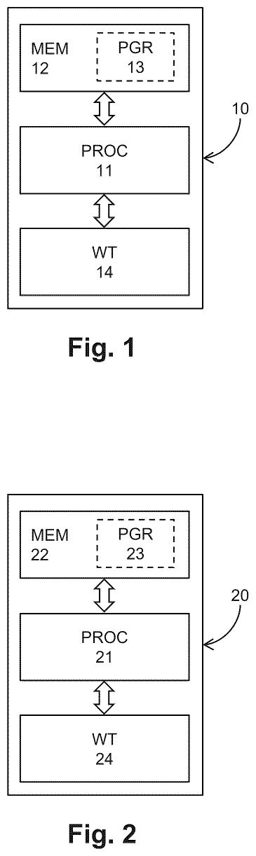

FIG. 2 represents schematically an example of a BS 20 suitable for implementing any method, discussed in the present disclosure, performed at a BS 20. For example, the BS 20 is a gNB. As illustrated by FIG. 2, the BS 20 comprises a processor 21 coupled to a memory 22. The memory 22 may store a computer program product 23, in the form of computer program instructions to be executed by the processor 21 to implement a method for DRX configuration, performed at a BS's side, according to any one of the embodiments disclosed herein. As illustrated by FIG. 2, the BS 20 comprises also a wireless transceiver 24 configured to exchange data with UEs. In preferred embodiments, the wireless transceiver 24 is 5G NR wireless transceiver.

As discussed above, the present disclosure aims at proposing a solution enabling to reduce DL data latency and signaling overhead when a single DRX configuration is configured by a gNB.

In the prior art, the network configures the DRX cycle value semi-statically through radio resource control, RRC, signaling and the UE then applies the same DRX cycle value in each DRX cycle.

In the present disclosure, it is proposed that the network (e.g., a gNB) may configure the DRX cycle value (i.e., long DRX cycle and short DRX cycle) dynamically for each DRX cycle, for example based on the traffic flows. Hence, the DRX cycle value may be adjusted to the requirements of the considered DL traffic flow, thereby improving DL data latency. In some examples, such a dynamic adjustment can be done via DCI or MAC CE, which reduces signaling overhead compared to reconfiguring the DRC cycle via RRC signaling.

Hence, based on the configuration received from the network, the UE can dynamically switch from one DRX cycle value to another, for example from a long DRX cycle to a short DRX cycle, or vice versa, at each DRX cycle. Of course, it is possible to consider more than two different values for the DRX cycle.

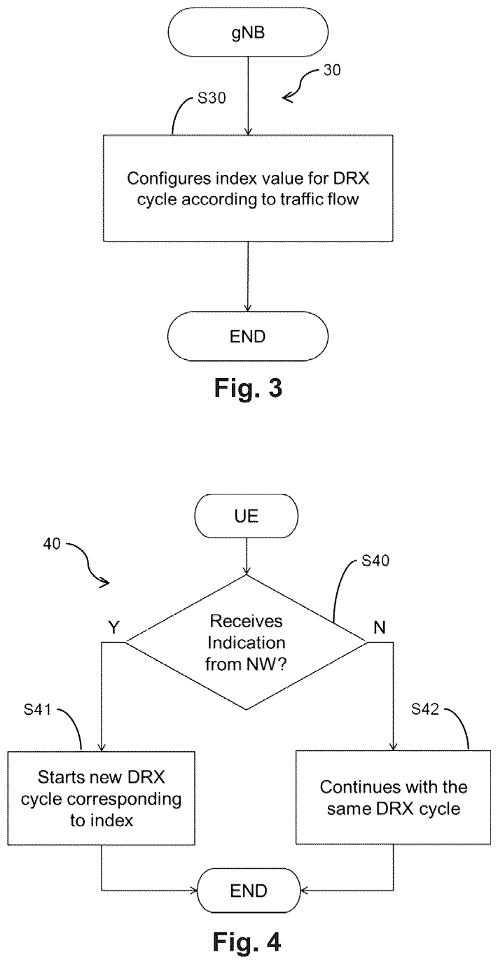

FIG. 3 represents a diagram showing steps of an exemplary embodiment of a method 30 for DRX configuration, which is implemented by a gNB 20.

The method 30 for DRX configuration comprises a prior step (not represented in the figures) of configuring semi-statically a DRX cycle value at the UE 10 through RRC signaling. For example, this configuration of the DRX cycle value may use a dedicated RRC signaling message such as an RRC reconfiguration message.

As illustrated by FIG. 3, the method 30 for DRX configuration comprises a step S30 of transmitting to the UE an indication of an adjustment of the DRX cycle value. For example, the adjustment indication is transmitted via DCI or MAC CE. For example, the adjustment indication is transmitted during an active time of the DRX cycle.

In the non-limitative example of FIG. 3, the adjustment indication is transmitted as an index, and the index is determined based on a traffic flow of the UE 10.

As indicated above, in some examples, the adjustment indication (e.g., index) may be transmitted as DCI or a MAC CE. In some examples, the adjustment indication (e.g., index) may be UE specific.

FIG. 4 represents a diagram showing steps of an exemplary embodiment of a method 40 for DRX configuration, which is implemented by a UE 10.

The method 40 for DRX configuration comprises a prior step (not represented in the figures) whereby the UE 10 is configured with a DRX cycle value by the gNB 20 through RRC signaling. For example, this configuration of the DRX cycle value may use a dedicated RRC signaling message such as an RRC reconfiguration message. This DRX cycle value, configured via RRC signaling, may be used by the UE 20 at each DRX cycle until it receives a adjustment indication which dynamically changes the DRX cycle value.

As illustrated by FIG. 4, the method 40 for DRX configuration comprises a step S40 of evaluating whether an indication of an adjustment of the DRX cycle value is received from the gNB 20. In the example of FIG. 4, it is assumed in a non-limitative manner that the adjustment indication comprises an index from which the UE 20 may determine the adjustment to be applied to the DRX cycle value. For example, the step S40 is executed during the active time of the DRX cycle.

If an adjustment indication is received during the active time, for example via DCI or MAC CE, then the method 40 for DRX configuration comprises a step S41 of modifying the DRX cycle value based on the indicated index, such that the UE 10 starts a new DRX cycle corresponding to the indicated DRX cycle value. In turn, if no adjustment indication is received from the gNB 20 (i.e., the gNB 20 does not indicate that the DRX cycle value needs to be modified or the received index is not correct), then the method 40 for DRX configuration comprises a step S42 of continuing with the same DRX cycle value as configured previously.

As indicated above, the UE 10 may determine the adjustment of the DRX cycle value based on the index indicated by the gNB 20. For example, the UE 10 may be preconfigured with a mapping table between a plurality of indexes and respective DRX cycle values.

In some embodiments, the mapping table between a plurality of indexes and respective DRX cycle values may be provided to the UE 10 by the gNB 20. For example, this mapping table between a plurality of indexes and respective DRX cycle values may be provided to the UE 10 through a dedicated RRC signaling message. For example, the dedicated RRC signaling message is an RRC reconfiguration message.

Table 1 represents a non-limitative example of a mapping between a plurality of indexes and respective DRX cycle values. In this example, three indexes and associated DRX cycle values are considered in a non-limitative manner.

TABLE 1

| Index | DRX cycle |
|---|---|
| X1 | DRX C1 |
| X2 | DRX C2 |
| X3 | DRX C3 |

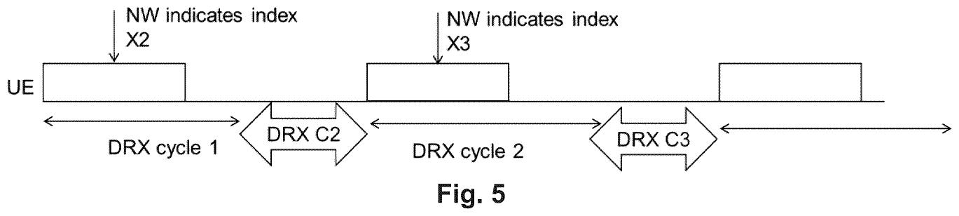

FIG. 5 shows an example in which two successive DRX cycles are represented and referred to as “DRX cycle 1” and “DRX cycle 2”. During the active time of the DRX cycle 1, the UE 10 receives from the gNB 20 an indication of the index X2. According to the mapping table illustrated by Table 1, the DRX cycle value associated to the index X2 corresponds to DRX C2. Hence, the UE 10 starts a DRX cycle (DRX cycle 2) corresponding to the value DRX C2 upon receiving the index X2 from the gNB 20. During the active time of the DRX cycle 2, the UE 10 receives from the gNB 20 an indication of the index X3. According to the mapping table illustrated by Table 1, the DRX cycle value associated to the index X3 corresponds to DRX C3. Hence, the UE 10 starts a DRX cycle corresponding to the value DRX C3 upon receiving the index X3 from the gNB 20.

In some embodiments, different index may further configure different DRX related timer, whereby the different DRX related timer include drx-onDurationTimer and/or drx-InactivityTimer and/or drx-RetransmissionTimer. Hence, in these examples, the adjustment indication may modify, within a given DRX cycle value (period), the respective durations of the active time and of the inactive time by e.g. modifying the drx-onDurationTimer and/or the drx-InactivityTimer and/or the drx-RetransmissionTimer. In such examples, it is therefore possible to modify, from one DRC cycle to another:
the DRX cycle value (period) (without modifying the duration of the active time),
the respective durations of the active time and of the inactive time without modifying the DRX cycle value, or
the DRX cycle value and the respective durations of the active time and of the inactive time, etc.

It is emphasized that the present disclosure is not limited to the above exemplary embodiments. Variants of the above exemplary embodiments are also within the scope of the present disclosure.

It should be noted that the following exemplary embodiments are also included in the present disclosure.

Embodiment 1: Method for DRX cycle for XR, wherein UE applies same DRX cycle value given by the Network which configures DRX-cycle semi-statically through RRC signaling, characterized by, that dynamic adjustment is done based on DCI or MAC CE.

Embodiment 2: Method according to Embodiment 1 characterized by the fact that the signaling is UE specific.

Embodiment 3: Method according to Embodiment 1 or 2 characterized by the fact that the UE is configured with more than one DRX cycle value which are associated with the index.

Embodiment 4: Method according to any one of Embodiments 1 to 3 characterized by mapping between the index and DRX cycle value are configured by RRC through dedicated RRC signaling message.

Embodiment 5: Method according to any one of Embodiments 1 to 4 characterized by the fact that DRX cycle value are configured by RRC through dedicated RRC signaling message.

Embodiment 6: Method according to any one of Embodiments 1 to 5 characterized by the fact that the RRC signaling message is the RRC reconfiguration message.

Embodiment 7: Method according to any one of Embodiments 1 to 6 characterized by the fact that the UE starts new DRX cycle according to the index indicated by network.

Embodiment 8: Method for DRX cycle for XR, wherein the Network (NW) which configures DRX-cycle semi-statically through RRC signaling, characterized by, that dynamic adjustment is done based on DCI or MAC CE.

Embodiment 9: Method according to Embodiment 8 characterized by the fact that the NW indicates index during the active time of UE.

Embodiment 10: Method according to Embodiment 8 or 9 characterized by, that the NW configures different DRX related timer, whereby the different DRX related timer are drx-onDurationTimer and/or, drx-Inactivity Timer and/or drx-RetransmissionTimer corresponding to different DRX cycle index.

Embodiment 11: Apparatus for DRX cycle for XR for a UE, the apparatus comprising a wireless transceiver, a processor coupled with a memory in which computer program instructions are stored, said instructions being configured to implement steps of any one of Embodiments 1 to 7.

Embodiment 12: Apparatus for DRX cycle for XR for a gNB, the apparatus comprising a wireless transceiver, a processor coupled with a memory in which computer program instructions are stored, said instructions being configured to implement steps of any one of Embodiments 8 to 10.

Embodiment 13: User Equipment comprising an apparatus according to Embodiment 11.

Embodiment 14: Base station comprising an apparatus according to Embodiment 12.

Embodiment 15: Wireless communication system, wherein the gNB comprises a processor coupled with a memory in which computer program instructions are stored, said instructions being configured to implement steps of any one of Embodiments 8 to 10, and wherein the user equipment (UE) comprises a processor coupled with a memory in which computer program instructions are stored, said instructions being configured to implement steps of any one of Embodiments 1 to 7.

### Abbreviations

BS Base station
C-RNTI Cell radio network temporary identifier
DCI Downlink control information
DL Downlink
DRX Discontinuous reception
MAC Medium access control
MAC CE
MAC control element
New radio
NR
PDCCH Physical downlink control channel
Physical uplink control channel
Radio resource control
PUCCH
RRC
SR
Scheduling request
User equipment
Uplink
UE
UL
XR Extended reality

1. A method for discontinuous reception, DRX, configuration, the method being implemented by a user equipment, UE, wherein the UE is configured with a DRX cycle value through radio resource control, RRC, signaling, wherein the method comprises:
in response to receiving from a base station, BS, via downlink control information, DCI, or medium access control, MAC, control element, CE, an indication of an adjustment of the DRX cycle value: modifying the DRX cycle value based on the indicated adjustment, in response to receiving no adjustment indication from the BS: continuing with the same DRX cycle value.

2. The method according to claim 1, wherein the adjustment of the DRX cycle value is determined based on an index indicated by the BS.

3. The method according to claim 2, wherein the adjustment of the DRX cycle value is determined based on a mapping table between a plurality of indexes and respective DRX cycle values.

4. The method according to claim 3, wherein the mapping table between a plurality of indexes and respective DRX cycle values is received by the UE through a dedicated RRC signaling message.

5. The method according to claim 4, wherein the mapping table between a plurality of indexes and respective DRX cycle values is received by the UE through an RRC reconfiguration message.

6. The method according to claim 2, wherein different index further configure different DRX related timer, whereby the different DRX related timer include drx-onDurationTimer and/or drx-InactivityTimer and/or drx-Retransmission Timer.

7. The method according to claim 1, wherein the adjustment indication is UE specific.

8. The method according to claim 1, wherein, the DRX cycle comprising an active time and an inactive time, the adjustment indication is received during the active time of the DRX cycle.

9. A user equipment, UE, comprising a wireless transceiver, a processor coupled with a memory in which computer program instructions are stored, said instructions being configured to implement a method according to claim 1.

10. A method for discontinuous reception, DRX, configuration, the method being implemented by a base station, BS, wherein a UE is configured with a DRX cycle value through radio resource control, RRC, signaling, wherein the method comprises transmitting to the UE an indication of an adjustment of the DRX cycle value via downlink control information, DCI, or medium access control, MAC, control element, CE.

11. The method according to claim 10, comprising determining an index and transmitting the index as an indication of an adjustment of the DRX cycle value.

12. The method according to claim 11, wherein the index is determined based on a traffic flow of the UE.

13. The method according to claim 11, comprising transmitting to the UE a mapping table between a plurality of indexes and respective DRX cycle values.

14. The method according to claim 13, wherein the mapping table between a plurality of indexes and respective DRX cycle values is transmitted to the UE through a dedicated RRC signaling message.

15. The method according to claim 14, wherein the mapping table between a plurality of indexes and respective DRX cycle values is transmitted to the UE through an RRC reconfiguration message.

16. The method according to claim 11, wherein different index further configure different DRX related timer, whereby the different DRX related timer include drx-onDurationTimer and/or drx-InactivityTimer and/or drx-Retransmission Timer.

17. The method according to claim 10, wherein the adjustment indication is UE specific.

18. The method according to claim 10, wherein, the DRX cycle comprising an active time and an inactive time, the adjustment indication is transmitted during the active time of the DRX cycle.

19. A base station comprising a wireless transceiver, a processor coupled with a memory in which computer program instructions are stored, said instructions being configured to implement a method according to claim 10.

20. A wireless communication system comprising: a base station comprising a wireless transceiver, a processor coupled with a memory in which computer program instructions are stored, said instructions being configured to implement a method for discontinuous reception, DRX, configuration, the method being implemented by a base station, BS, wherein a UE is configured with a DRX cycle value through radio resource control, RRC, signaling, wherein the method comprises transmitting to the UE an indication of an adjustment of the DRX cycle value via downlink control information, DCI, or medium access control, MAC, control element, CE; and the user equipment, UE comprising a wireless transceiver, a processor coupled with a memory in which computer program instructions are stored, said instructions being configured to implement a method according to claim 1.
